(19) United States
(12) Patent Application Publication
(10) Pub. No.: US 2002/0128844 A1
(43) Pub. Date: Sep. 12, 2002

(54) Telephonic certification of electronic death registration

(76) Inventors: Raymond E. Wilson, Placerville, CA (US); Roger L. Duerksen, Salem, OR (US); Mark J. Gleason, Costa Mesa, CA (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/055,427

(22) Filed: Jan. 23, 2002

Related U.S. Application Data
(60) Provisional application No. 60/263,958, filed on Jan. 24, 2001.
(60) Provisional application No. 60/343,509, filed on Dec. 21, 2001.

(51) Int. Cl. G10L 21/00

(52) U.S. Cl. 704/270

(57) ABSTRACT

A system for facilitating an electronic signature of a document such as a death certificate includes a voice authentication unit, a voice recognition and a database for storing information relating to the electronic signature ceremony. The system includes an enrollment interface to telephonically receive a reference voiceprint from a future signer of the death certificate, for example a physician. The system is further configured to receive an authentication voiceprint from the enrolled physician wherein the voice authentication unit compares the reference voiceprint and the authentication voiceprint to confirm identity. The system employs the voice recognition unit to allow the physician to telephonically perform at least one of the functions selected from the group including (i) identifying the death certificate, (ii) entering data into the death certificate, or (iii) affirming data that is in the death certificate. The system provides improved ease of use, more rapid and accurate signing of death certificates and is more secure than prior systems.

### RELATED APPLICATIONS

This application claims the benefit of U.S. Provisional Application Serial No. 60/263,958 filed Jan. 24, 2001 and U.S. Provisional Application Serial No. 60/343,509 filed Dec. 21, 2001, both provisional applications being hereby incorporated by reference in their entireties.

### FIELD OF THE INVENTION

The present invention relates generally to systems and methods for electronic signature of documents, transactions or events utilizing biometric security and voice recognition.

### BACKGROUND OF THE INVENTION

State governments are required by law to establish and operate birth, marriage and death registration systems. Currently, the state systems for death registration are nearly all-manual systems supported in only the most rudimentary way by computer applications (e.g., word processing). However, during the next three years, it is expected that most states will adopt electronic death registration (EDR) to more efficiently issue death certificates. Pilot studies to date have indicated that the major implementation hurdles are collecting signatures and physician participation. If the only way to obtain a signature is in the traditional wet ink on paper fashion, then the entire electronic record-handling process is subverted. Additionally, physicians are reluctant to spend time to learn how to use new software and processes developed for EDR, mostly due to the complexity of the software and processes.

Briefly and as shown in FIG. 8, a prior art death registration system requires a physician's physical signature that is acceptable to the health department, which is often difficult to obtain. Specifically, after death occurs, as shown in step 810, it must be determined whether or not such death was attended by a physician, as shown in decision block 812. If not, a coroner must be contacted, as shown in step 814. If the physician so attended, a funeral director must be contacted for further attention to the matter, as shown in step 816.

In step 818, the funeral director contacts the certifier (i.e., the attending physician), to obtain data needed to fill out a death certificate for the deceased. This activity may also involve meeting with the family (step 820) to obtain personal or other non-medical information. The funeral director then completes the death certificate manually, for example on a typewriter or a computer, as shown in step 822. The funeral director then has to physically take the death certificate to the physician for the physician's handwritten, ink signature, as shown in step 824. If the physician is unavailable to sign, as determined in decision block 826, the funeral director must continue to make efforts (the overall process loops back to step 824). This potential “looping” can require a considerable amount of time, depending on the availability of the physician. In addition, if during this process the death certificate becomes damaged due to rain or other causes, it must be retyped and resigned, as explained in block 828.

Once the death certificate is “signed,” the funeral director may deliver it, along with an application for a burial permit, to the health department, as shown in step 830. However, the department will examine the certificate and determine if it is acceptable, as shown in step 832. If the certificate is rejected by the health department (i.e., if the signature is in the wrong color ink or is not completely inside the signature box, as explained in box 834), the funeral director must start over with preparation of a brand new death certificate (i.e., loop back to step 822). However, if acceptable, the department may approve the burial permit, as shown in step 836. This approach is inefficient, costly, complex, and potentially slow.

The requirement for a handwritten signature therefore complicates the foregoing process as well as many other processes. In response, the art has attempted to solve the challenges involved with handwritten signatures, as seen by reference to U.S. Pat. No. 5,544,255 to Smithies et al. entitled “METHOD AND SYSTEM FOR THE CAPTURE, STORAGE, TRANSPORT AND AUTHENTICATION OF HANDWRITTEN SIGNATURES.” Smithies et al. disclose a system for electronically affirming a document, transaction or event. Smithies et al. further disclose recording different types of signatures, including voice recordings. However, Smithies et al. do not verify or authenticate the voice print of the signer, but rather merely stores the voice print recording, principally as evidence of the signer's intent. In another embodiment, however, Smithies et al. disclose that a transcript object (i.e., containing the recording of the voiceprint) can be accessed by a signature verification system to verify those electronic signatures which are based on biometric data. However, the system of Smithies et al. would appear to continue to present shortcomings, inasmuch as Smithies et al. further suggests that the transcript object can be accessed at a later date. Verification is therefore not done in real time. The timing of the verification, in such circumstances, would therefore be of no use in the example above, since the signer (e.g., the physician) would have to be called back (or call back), or otherwise tracked down in order to get him/her to “sign” again if a problem were detected at such later date through such verification. In this regard, then, the system of Smithies et al. is no different than the prior art manual process set forth in FIG. 8, with its shortcomings.

There is therefore a need for a system and method for facilitating an electronic signature that minimizes or eliminates one or more of the shortcomings set forth above.

### SUMMARY OF THE INVENTION

One object of the present invention is to provide a solution to one or more of the problems set forth above. The present invention relates to electronic signature methods and systems utilizing biometric security. A system and method according to the invention is efficient, easy to use, accurate, secure and rapid. It overcomes shortcomings of conventional approaches, in a preferred embodiment, by combining the use of voice authentication to confirm the identity of a signer of document, with voice recognition to facilitate entering or affirming data in (or allowing identification of) the document to be signed, all conducted telephonically. In a preferred embodiment, authentication is done in “real time” (i.e., during the course of the call), thereby overcoming the callback and tracking down of the signer problems associated with conventional systems.

A method for facilitating an electronic signature of a document includes three basic steps. First, biometrically authenticating a signer of the document using a telephone network (i.e., telephonically). Preferably, this step may be performed by comparing an authentication voiceprint with reference voiceprint on file. Next, allowing the signer to telephonically perform, using voice recognition, at least one of the following functions: identifying the document to be signed; entering data into the document to be signed; or affirming data in the document to be signed. For example, the method may involve generating an audible description of the document to be signed with a query “Is this the document to be signed?” The signer may respond over the telephone “yes.” The use of voice recognition eliminates cumbersome and error-prone use of the telephone keypad, for example. Finally, the third basic step involves telephonically receiving the electronic signature from the signer. In a preferred embodiment, this step may also involve the use of voice recognition (e.g., the signer may say “certify” into the phone, which would be recognized via voice recognition).

In a still further, preferred embodiment where the document to be signed is a death certificate, the method comprises the steps of authenticating a physician's voiceprint to confirm that the physician is who he says he is, and obtaining telephonically an authorized signatory's physician's certification of a death certificate. The method may further include the step of forwarding the certified death certificate to a state health department or the like electronically, and may be recorded and stored electronically so that the certificate and any information on the certificate may be retrieved at a later time.

In another aspect of the invention, the method further includes the step of repeating the certification process for a plurality of documents. This aspect has the advantage of relieving the signers from having to “hang up” and call back for each document to be signed.

In a still further aspect of the invention, the method further includes the step of initially authenticating the signer using a personal identifier (e.g., a PIN, password or the like, which is capable of uniquely identifying an individual) in order to obtain a reference voiceprint; associating the reference voiceprint with the signer; and thereafter using the reference voiceprint for authentication purposes at least a plurality of times (when “signing” documents).

In a still yet further aspect of the invention, output data indicative of the degree of match between a reference voiceprint and an authentication voiceprint is stored in a database for subsequent auditing purposes.

Other objects, features, and advantages of the present invention will become apparent to one skilled in the art from the following detailed description and accompanying drawings illustrating features of this invention by way of example, but not by way of limitation.

### BRIEF DESCRIPTION OF THE DRAWINGS

FIG. 1 is a simplified block and flow diagram of a system and method according to the invention.

FIG. 2 is a block diagram showing, in greater detail, the system for facilitating electronic signatures according to the invention.

FIG. 3 is a flowchart diagram illustrating a method of the present invention.

FIGS. 4-6 are flowchart diagrams showing the detailed process flow of a preferred embodiment of the certification and signature functions of the present invention.

FIG. 7 is a flowchart diagram illustrating an enrollment function of a preferred embodiment of the present invention.

FIG. 8 is a flowchart illustrating the general schematic of a prior art death registration system.

### DETAILED DESCRIPTION OF THE INVENTION

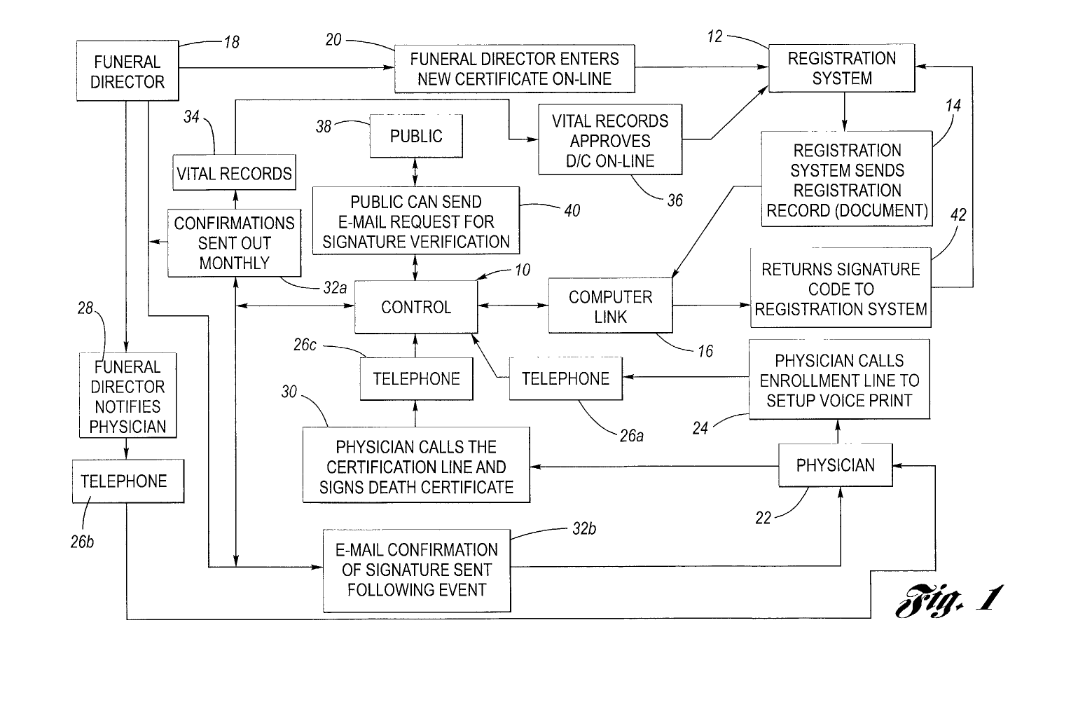

Referring now to drawings wherein like reference numerals are used to identify identical components in the various views, FIG. 1 shows a system 10 for facilitating an electronic signature of a document, for example, received from a registration system 12. Registration system 12 may comprise conventional arrangements known to those of ordinary skill in the art for managing documents, for example, those to be “registered”. For example, registration system 12 may be a relational database type system employing conventional database management products, such as Oracle. In one embodiment, registration system 12 may comprise a commercially available product under the name VITALVISION from VitalCheck Network, Inc., Hermitage, Tenn. USA, which is of the type for managing vital records such as birth, death, marriage and divorce certificates. Before proceeding to a detailed description, however, a general overview will be set forth.

### Overview

System 10 according to the invention allows an individual to electronically “sign” a document using a telephone. System 10 may be referred to herein at times as a Physician Certification Line (PCL) system 10 in a death certificate registration embodiment. It should be understood that other systems consistent with the invention operate in a very similar manner, as applied to other types of documents. Such other documents may includes, but are not limited to, birth certificates, marriage or divorce certificates, medical records or medical prescriptions.

With continued reference to FIG. 1, a computerized registration system 14 first sends information corresponding to the document to be signed, or system 10 retrieves such information from registration system 14. The received data is stored in a database associated with system 10. In the death certificate example shown in FIG. 1, a funeral director 18 may initially access registration system 12 to populate a form or the like with data to be included in the death certificate. This activity is shown in block 20.

The person who must electronically “sign” the document must enroll on system 10 so that the system can later identify (i.e., authenticate) that person. Again, in the death certificate embodiment of FIG. 1, the person is the physician 22 who attended the death of the deceased. Physician 22 calls into an enrollment line to commence the enrollment process and setup a reference voiceprint, as shown in step 24. Such a call may be made via telephone network 26a. It should be understood that although a “solid” line connects the physician to the phone network 26a, and thence to system 10, access to network 26a (or to networks 26b or 26c) need not be a wireline arrangement, and may include wireless access methods, as known. System 10 may also keep a record of the person's address, phone number, etc. for follow up confirmations of signature(s).

Once system 10 has a document record and the signer has enrolled, the signer then calls a certification line coupled to system 10 to “sign” the document. Again, in the death certificate embodiment in FIG. 1, after a death occurs (and the director creates a death certificate, which is ultimately stored in the database of system 10), the director notifies the physician (in step 28) that a death certificate is ready to be signed. Such notification may be done by way various conventional methods (shown in exemplary fashion as via telephone 26b). Once the signer/physician calls and is connected to the certification line (step 30) via telephone network 26c, the signer/physician states his or her name. The system 10 then attempts to authenticate the identity of the caller using voice authentication technology.

After authentication, system 10 looks up the records to be ‘signed’ by that particular person and offers to allow the person to ‘sign’ each one. Once signed, the record is removed from “pending” status and is added to the certification table, which also contains a copy of the person saying their name, as well as the electronic signature (e.g., the physician saying “certify”). System 10 also records the date and time of certification.

System 10 will then return the signature information to the registration system 14 originally requesting a signature. If the data was acquired through polling, then upon the next polling of that registration system by system 10, such signature information will be uploaded. System 10 preferably returns a signature code, date and time of the signature as well as who made the signature, as shown in block 42.

On a periodic basis, for example once a month, system 10 will send out confirmations to interested parties. The confirmations would be processed as follows.

The funeral director 18 will receive confirmations on every record signed for it, as shown in block 32a.

The certificate issuing agency will also get confirmations on every item signed for it, also shown via block 32a to a vital records agency 34. Vital records 34 may approve of the signed death certificate electronically, as shown in block 36.

The signer (e.g., physician 22) will also receive confirmation of each item they signed, as shown in block 32b via e-mail.

The state shall receive confirmations on all records signed within that state.

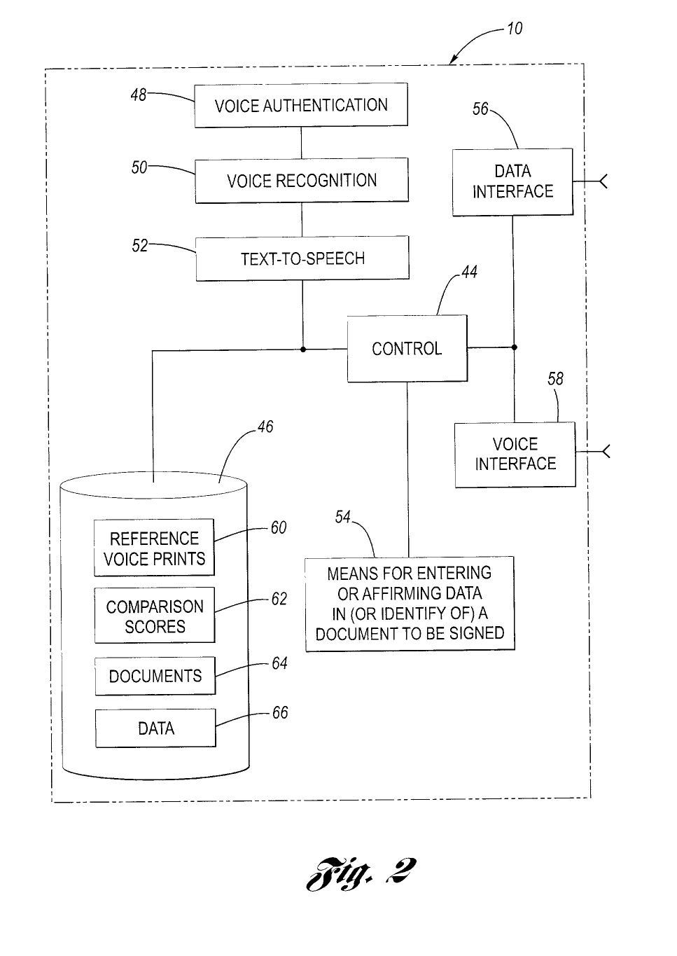

Once a signature code is printed on a registered certificate, it can be verified by e-mail or other electronic access such as Internet access, by specifying the signature code. System 10, for example, may be configured to extract the data from the email or other Internet transaction, such as an inquiry by a member of the public (shown in blocks 38 and 40). System 10 is further configured to look up the record in the signature table, and return an e-mail or other Internet response to the sender advising of the name of the signer and other information regarding the certificate. With this overview, attention is now drawn to a detail of system 10, in FIG. 2.

FIG. 2 is a simplified block diagram showing, in greater detail, the system 10. System 10 is configured to facilitate an electronic signature of a document, and includes a main control unit or processor 44, a database 46 coupled thereto, a voice authentication unit 48, a voice recognition unit 50, a text-to-speech processor 52, means or circuit 54 for allowing or facilitating a signer to enter or affirm data in (or affirm the identity of) the document to be signed, a data interface 56, and a voice interface 58.

Control 44 oversees the overall operation of system 10 and may comprise conventional and well-known apparatus, for example, general purpose computing apparatus. Control 44 may be programmed to perform the functionality described herein, when coupled to various data sources and functional blocks, to be described below.

Database 46 is provided for storing a variety of data used before, during, and after the electronic signing of a document. Database 46 may also comprise conventional and well-known technology known to those of ordinary skill in the art. For example, database 46 may be a conventional database, a flat file, or any other structure or mechanism known in the art to store or maintain and allow retrieval of data or other information. Database 46 may include a first portion 60 containing a plurality of reference voiceprints, a second portion 62 containing comparison scores obtained during voice authentication, a third portion 64 containing a plurality of documents to be signed, and a fourth portion 66 containing a variety of other operating and configuration data (e.g., audio message data, text data to be converted by unit 52, and the like).

Voice authentication unit 48 provides the means for authenticating a signer based on an authentication voiceprint received from the signer over a telephone network. In this regard, as understood by those of ordinary skill in the art, the voice authentication unit 48 is configured to compare the authentication voiceprint with a reference voiceprint and generate an output data set comprising comparison scores. The scaled comparison scores provide a measure of the degree of match between the reference voiceprint and the authentication voiceprint offered to authenticate the signer. The threshold for allowing authentication of a signer is selectable. Voice authentication unit 48 may comprise conventional software, hardware, or a combination thereof. In one embodiment, voice authentication unit 48 may comprise a product commercially available under the name NUANCE VERIFIER 3.0 from Nuance, Menlo Park, Calif., USA. Of course, there are many other sources of voice authentication technology well known to those of ordinary skill in the art. It should be understood that the foregoing is merely exemplary only, and not limiting in nature.

Voice recognition unit 50 is configured to recognize and convert voice or speech segments into words, numbers or the like. It is important to distinguish voice recognition unit 50 from voice authentication unit 48. Voiceprints are unique to an individual and, for all practical purposes, no two voiceprints are exactly alike. Voice authentication unit 48 is configured to verify or authenticate the identity of a person. That is, it is a biometric implementation of a process of identifying an individual to ensure that the individual is who he or she claims to be. On the other hand, voice recognition unit 50 is configured to accurately recognize words, symbols and numbers across a broad range of user speech patterns, accents, dialects, and the like. Voice recognition unit 50 is based on technology that is generally well understood to those of ordinary skill in the art, and may comprise conventional software, hardware, or a combination thereof. In one embodiment, voice recognition unit 50 may comprise a product commercially available under the name NUANCE 8.0 from Nuance, Menlo Park, Calif., USA. The foregoing is exemplary only and not limiting in nature.

Text-to-speech unit 52 is configured to convert words, symbols, numbers and the like in text form (e.g., data form) into speech or voice. Such speech may then, under the management of control unit 44, be sent, by way of voice interface 58, to a signer (e.g., physician) in the way or prompt, to affirm data present in the document, to identify a document, or in other ways described herein. Text-to-speech technology, in general terms, is well understood by those of ordinary skill in the art, and may comprise software, hardware, or a combination thereof. Text-to-speech unit 52 may, in one embodiment, comprise a product commercially available under the name NUANCE VOCALIZER from Nuance, Menlo Park, Calif., USA.

Means or circuit 54 is configured to provide a variety of functions using voice recognition unit 50 and either text-to-speech unit 52 or prerecorded audio messages. These functions include allowing the physician (or other individual in other embodiments) to (i) identify the document to be signed; (ii) enter data into the document to be signed; or (ii) affirm data in the document to be signed. The foregoing approach avoids the use of the touch pad of the telephone or the like, which is difficult to use, slow in entering data/responses, and is prone to error. Use of voice recognition unit 50 in implementing means or circuit 54 improves ease of use, reduces mistakes, and enhances the probability of adoption of system 10 by subscribers or users.

Data interface 56 is configured to provide a data interface for system 10 to the outside world. Interface 56 may be configured for network connectivity (e.g., Ethernet for a LAN or Internet connection), analog data connection (e.g., modem interface for data “dial-in”), or in other ways known to those of ordinary skill in the art. For example, interface 56 may further be configured to receive e-mail formatted according to conventional e-mail protocols. Interface 56 allows input/output of data, and may comprise conventional arrangements known to those of ordinary skill in the art.

Voice interface 58 is configured to provide a voice (e.g., telephone switched network) interface for system 10. For example, physician enrollment and certification calls may passed through interface 58, which may comprise conventional arrangements known to those of ordinary skill in the art.

It should be understood, however, that illustration of interfaces 56 and 58 are merely exemplary only, and not limiting in nature. There are known methods, for example, of carrying voice over data transmission networks (e.g., ISDN, Voice over IP, etc.). Thus, the segregation of voice and data in the drawings is not intended to, nor should be construed as, requiring distinctness between the two functional blocks, but only to illustrate that the system involves both “data” and “voice,” in a preferred embodiment.

Initial data acquisition is the process whereby system 10 (e.g., PCL system 10 in a preferred death certificate embodiment) obtains information from registration system 12 and returns data on certifications to registration system 12. There are three contemplated, preferred approaches.

The first, which may be seen by way of reference to FIG. 1, is an electronic document interchange whereby the registration system 12, operated by the certificate issuing agency, formats the information required by the system 10 into a record corresponding to the document to be signed all in accordance with a predetermined format. Additionally, such record may conform to a standard data exchange language like XML (or other data type). Registration system 12 then encrypts the information in the record and sends the encrypted record (shown in block 14 in FIG. 1) via a data connection, for example, through the Internet (shown a block 16 in FIG. 1), to system 10. Upon receipt of the encrypted record, system 10 decrypts the information and then adds the decrypted record to its database 46, grouped with “pending” records (i.e., documents still to be signed). When the document is signed, the corresponding record in database 46 has its status changed to “completed”. At a preselected time, system 10 sends an encrypted XML (or other data type) record back to the registration system 12 (shown in block 42 in FIG. 1), and which contains a signature code (to be described in greater detail below) as well as the date and time registration took place, who signed the document, and any other information related to the record that is required by the issuing agency.

The second approach is e-mail based, whereby the registration system 12 sends data packaged in an e-mail message addressed to system 10 in a secure fashion, for example, by encrypting the e-mail message (and any attachments thereof). Upon receipt of the encrypted e-mail message, system 10 decrypts the received e-mail, and then adds the record to database 46 (again, having a “pending” status associated therewith, group with other “pending’ records). When the document is signed, system 10 then sends a secure (e.g., encrypted) e-mail message addressed to the registration system 12, and which contains the above-mentioned signature code, the date and time registration took place, who (i.e., the identity of the person) signed the document, and any other information related to the record that is required by the issuing agency.

The third approach involves a polling program for the State of California with connection to University of California at Santa Barbara's Automated Vital Statistics System (AVSS). According to this approach, system 10 periodically calls (“polls”) a corresponding AVSS computer for each county (local) registrational district (LRD), and enters a login identifier and a password to gain access. System 10 is further configured to navigate various menu selections presented by the AVSS computers and is adapted to obtain a data dump of all records corresponding to documents to be signed. System 10 is further configured to send signature codes and verifications to the AVSS system as well as verify any signatures already submitted and requested by or through the AVSS system. The data dump translates to data records, which are stored in the database 46 (and, like the above approaches, are group with other “pending” records). Before a document can be signed by a physician, however, he/she must be enrolled.

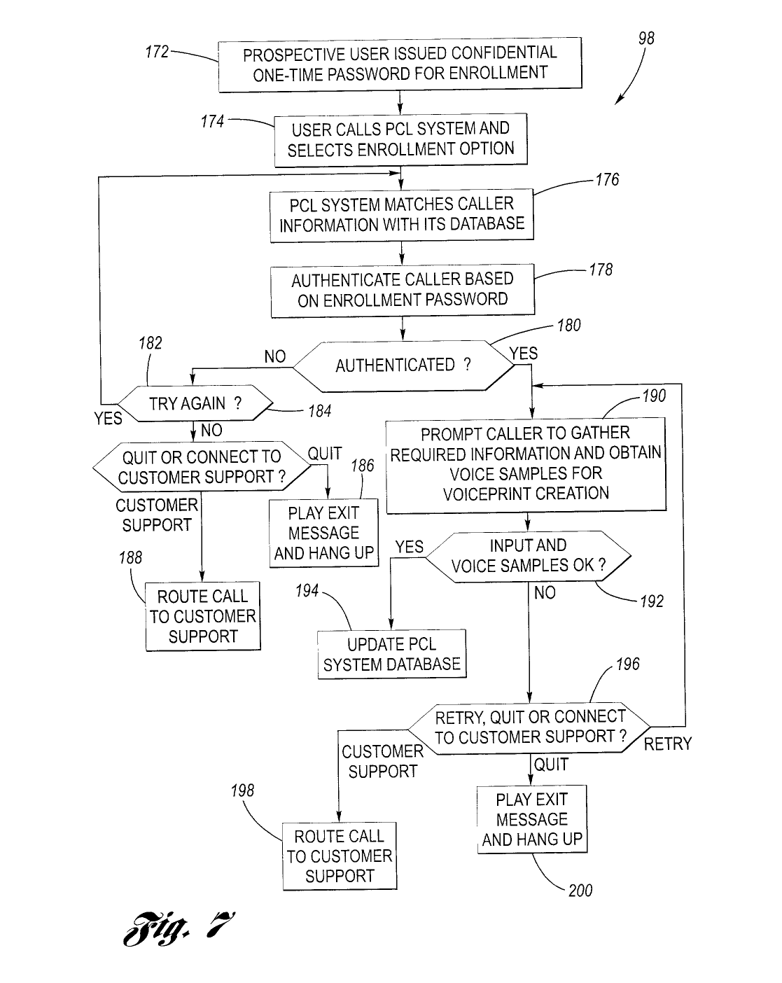

FIG. 7 is a flowchart diagram showing the steps involved with enrolling a “signer” of document, including those steps performed by system 10. Enrollment is the process whereby the physician, after being authenticated, registers his/her reference voiceprint for later comparison (for biometric authentication for “signing” documents). The process begins in step 172.

In step 172, the physician completes a form or other otherwise provides preselected information, and mails, faxes or otherwise transmits it to system 10 or, in the alternative, to the certificate issuing agency. The physician is then issued a one-time-use personal identifier, such as a PIN, a password or any other means to uniquely identify an individual. The process proceeds to step 174.

In step 174, the physician (“signer”) calls an enrollment telephone number, which, to improve security, may be separate from and distinct from the telephone line used for certification activities. In another embodiment, a general phone number is called, and system 10 presents speech-based options, one of which is enrollment, which the physician may select orally (system 10 employs voice recognition). System 10, telephonically, welcomes the physician and provides some detailed instructions on what the system 10 will expect. The process then proceeds to step 176.

In step 176, system 10 asks the physician to enter his/her license number or other required identifying information, either by (i) preferably, speaking to the voice recognition unit 50 or (ii) through the telephone keypad. If the telephone keypad approach is used, one input approach may involve two strokes are used for entering letters, the first designates what key on the telephone pad the letter resides and the second gives the order on the key that letter occupies. For example, K would be 52. It is on the 5 key and is the second letter. System 10 then finds the physician in its database 46. The process then proceeds to step 178.

In step 178, system 10 checks to see if that physician is already enrolled. If not, system 10 will ask the physician to input the password, PIN or other identifier in order to authenticate the identity of the physician. It bears emphasizing that, in a preferred embodiment, entry of the identifier is a one-time occurrence, all future authentication of identity being made through telephonic biometric means preferably. The invention has the advantage of minimizing the use of telephone keypads and the like, which are relatively difficult to use (e.g., especially small cell phones), slow, and relatively error-prone. The process then proceeds to decision block 180.

In block 180, system 10 determines whether the PIN, password or the like referred to above matches that issued to the physician for this one-time enrollment use. If the authentication fails (no match), then the process branches to decision block 182. Otherwise, the process proceeds to step 190.

In block 182, system 10 prompts the physician as to whether he/she wishes to try again. If the response is “YES,” then the process branches back to step 176 (enter ID step). If the response is “NO,” then the process branches to decision block 184.

In block 184, the system 10 prompt the physician as to whether he/she desires to quit the enrollment process, or whether he/she wishes to be connected to customer support or other form of assistance. If the response is “QUIT,” then the process branches to step 186, otherwise, the process branches to step 188. In step 186, system 10 plays an exit message and disconnects the physician. In step 188, the physician's call is transferred or otherwise routed to customer support or other form of assistance.

In step 190 (identifier matches), system 10 prompts the physician for other predetermined information as well as obtains voice samples for creation of one or more reference voiceprints. In a preferred embodiment, system 10 asks the physician to say his/her name exactly like they would “sign” their name if done by handwriting. The system 10 will ask the physician to state his/her name and/or other information a specified number of times. Each time, the voice authentication unit 48 will extract a segment of the physician's speech for storage and future use. The process proceeds to decision block 192.

In block 192, system 10, particularly the voice authentication unit 48, determines whether the input voice samples are sufficient to establish one or more reference voiceprints. If “YES,” then the process branches to step 194, wherein system 10 updates its database 46, particularly its reference voiceprints portion 60. In addition system 10 may thank him/her for participating. System 10 may further create a sample death certificate for use by the physician in training. This allows the system (e.g., a trainer module thereof) to immediately have the physician try out the certification process before they must do it on his/her own.

If the voice samples taken were inadequate (“NO”), however, then the process branches to decision block 196.

In block 196, the system 10 asks the physician whether he/she desires to “RETRY,”“QUIT” or “CONNECT TO CUSTOMER SUPPORT”. If the physician wishes to be connected to customer support (e.g., as may be determined by the physician's oral response, recognized by voice recognition unit 50), then the process branches to step 198, wherein the physician's call is routed to customer support or other form of assistance. If the physician wishes to “QUIT” (e.g., as may be determined by the physician's oral response, recognized by voice recognition unit 50), then the process branches to step 200, wherein system 10 plays an exit message or the like, and disconnects the physician's call. If the physician wishes to “RETRY” (e.g., as may be determined by the physician's oral response, recognized by voice recognition unit 50), then the process branches back to step 190 to repeat capture of voice samples, as described above.

However, if (in step 176) system 10 determines that the physician has already enrolled, then the system 10 will ask for the physician to say his/her name exactly like they would sign their name. This particular type of response reduces the degree of match required for authentication and confirms that the physician is who he/she has stated. If it matches (i.e., biometrically, telephonically authenticate the physician's identity), he/she is allowed to enroll on a new device. This process may occur up to seven times and allows the physician to enroll on devices that may be troublesome in noise levels or quality and thereby making it difficult to verify within the original enrollment. For example, the physician may enroll on his/her office phone, home phone, pay phone, cell phone and the like.

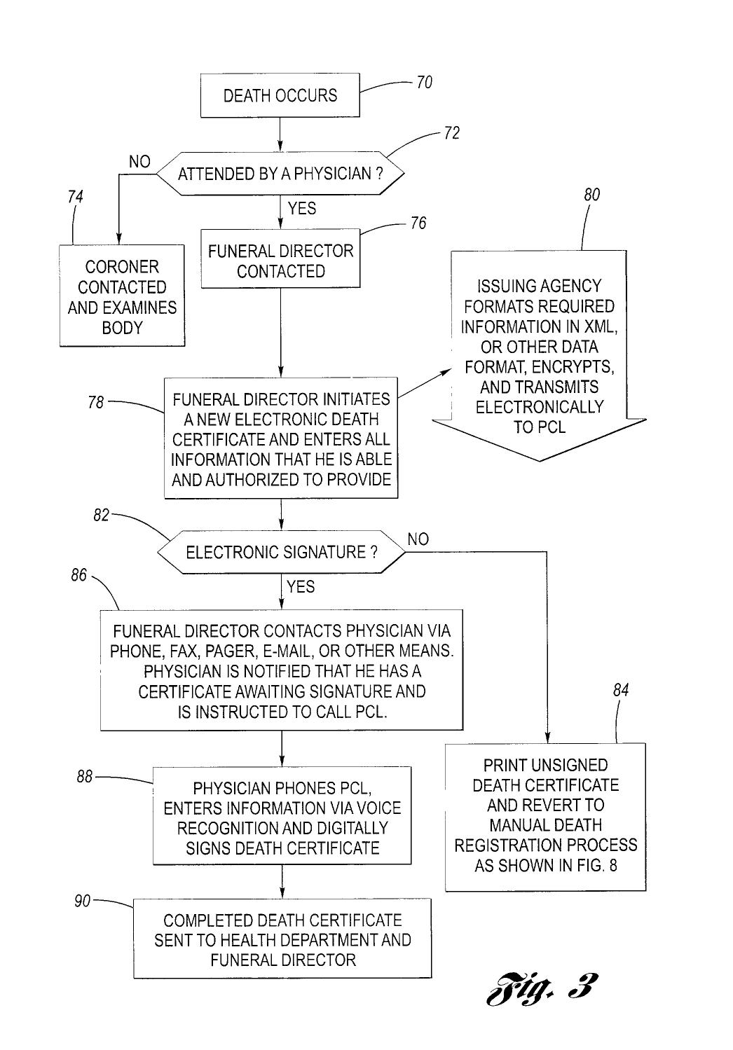

FIG. 3 shows the basic method according to the invention for electronically signing a document, such as a death certificate. The method begins in step 70, wherein a death occurs. In decision block 72, it must be determined whether such death was attended by a physician. If the answer is “NO,” then the method branches to step 74, wherein a coroner is contacted to examine the deceased. However, if the answer is “YES,” then the method branches to step 76. In step 76, a funeral director is contacted.

In step 78, the funeral director initiates a new electronic death certificate and enters all the information that he/she is able and authorized to provide (more on this below where alternatives are described in detail). A new, unsigned electronic death certificate is usually created by a funeral director, but may also be created by any other party authorized by the certificate issuing agency, including hospitals, nursing homes, hospices, emergency services, and medical examiners. A new electronic death certificate is originated by the authorized party by entering required data into a computer system operated by the certificate issuing agency, or a registration system 12 (best shown in FIG. 1). Access to such a system would typically be enabled via a secure Internet (or other electronic) connection. Entry of data by the certificate originator would typically be via a screen or series of screens presented to the user in a web browser. Other methods could include entry of data via a dedicated connection to the issuing agency's computer system and data entry screens presented in client/server format, via voice recognition over a telephone, or via manual transcription by the issuing agency of paper documents. The method then proceeds to step 80.

In step 80, a certificate issuing agency (perhaps via registration system 12, best shown in FIG. 1) formats the information, as described above, and transfers, through any of the above methods, such formatted information to system 10. The method then proceeds to decision block 82.

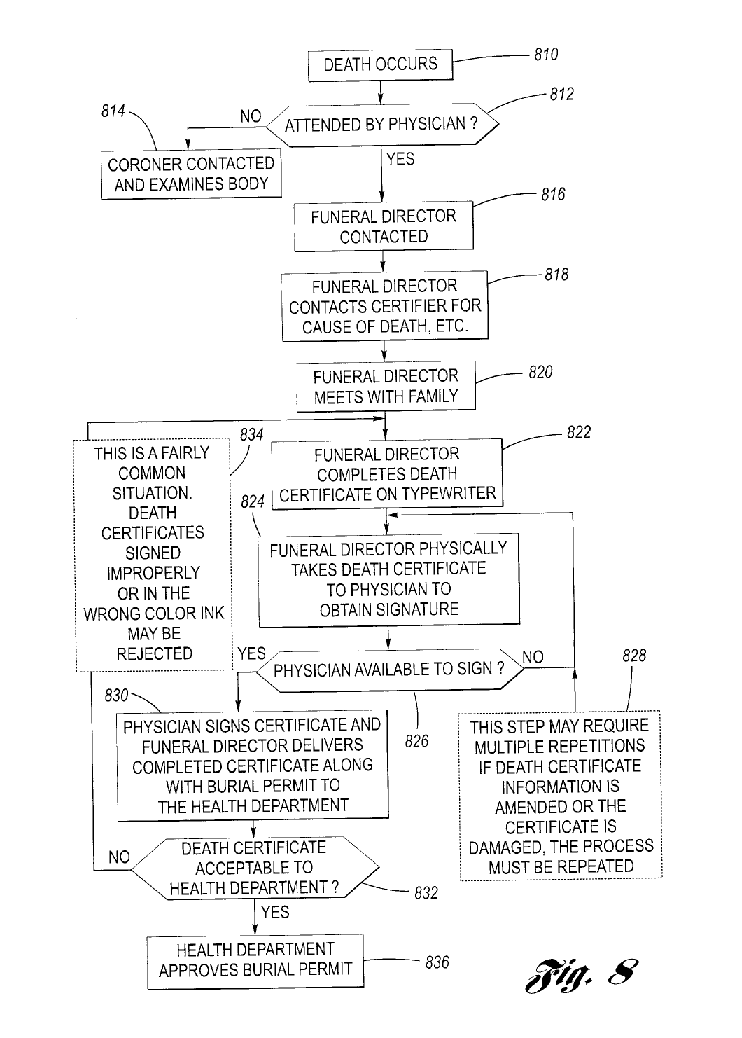

In block 82, the method determines whether an electronic signature is to be employed in this instance. If the answer is “NO,” then the method branches to step 84, wherein the death certificate is printed, and the process, essentially, reverts to the conventional process described and illustrated in connection with FIG. 8. On the other hand, if the answer is “YES,” then the method branches to step 86. In step 86, the funeral director contacts the physician to let him/her know that a death certificate is awaiting electronic signature. In step 88, the physician calls into system 10, which biometrically, telephonically authenticates the physician, who then “signs” the death certificate. In step 90, the completed death certificate is sent, by system 10, to various interested parties, such as the health department and the funeral director. The physician gets a confirmation of the transaction (“signing” of the certificate).

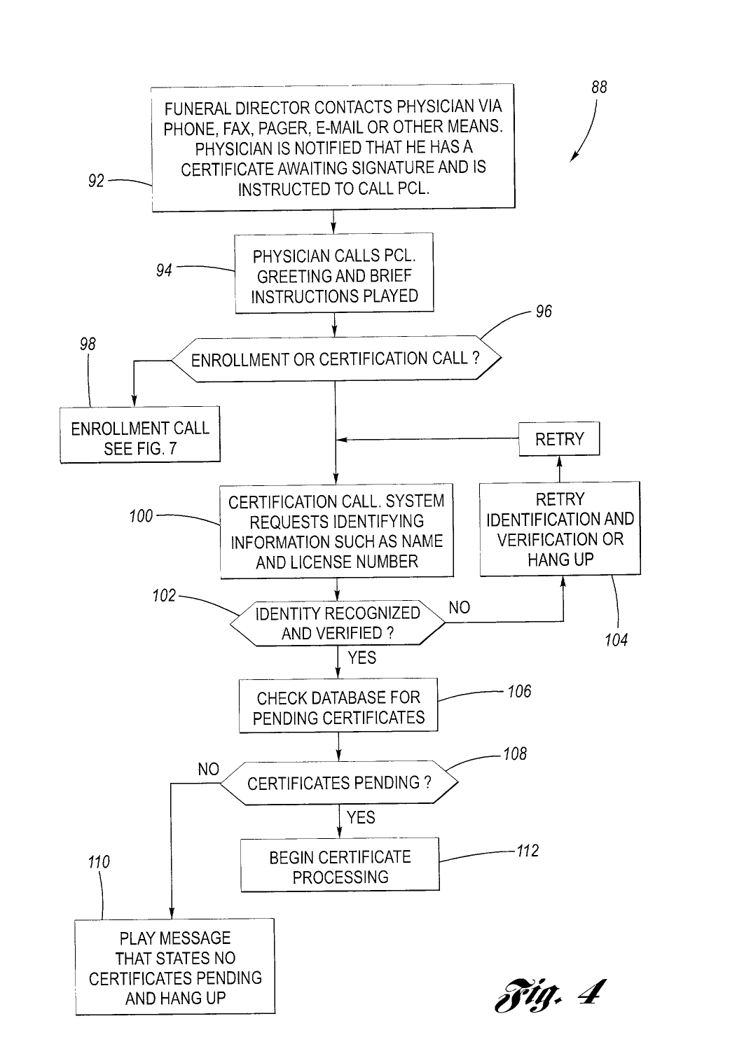

FIG. 4 shows, in greater detail, step 88 of FIG. 3 (physician certification “call in” process).

In step 92, once a new, unsigned or otherwise incomplete electronic death certificate is created by an authorized party, the attending physician must be notified to call over a telephone network into system 10 to telephonically, electronically “sign” the certificate.

There are two approaches for doing this. In a first preferred embodiment, the funeral director (or authorized party) who originated the now-pending certificate directly contacts the physician via telephone, fax, pager, e-mail, in person, or by any other means available. The physician is then informed that a certificate is awaiting completion and given instructions to call the certification phone number (e.g.,which may be a toll-free phone number).

In a second preferred embodiment, the certificate originator, at the time that they have completed the origination of a new certificate, requests that the system 10 contact the physician. The certificate originator may make this request by checking an appropriate box in the electronic death registration form, on another web page, or by entering information on a separate system. Once system 10 receives the request for the notification to be made, system 10 will automatically contact the physician via telephone (e.g., using text-to-speech unit 52 or a prerecorded audio message), fax, pager, or e-mail. The physician is then informed by the system 10 via voice prompts or textual information, depending on the contact method, that a certificate is awaiting completion and given instructions to call the certification phone number. The method then proceeds to step 94.

In step 94, once the attending physician is informed that a certificate is awaiting completion, he/she phones system 10, as described above. System 10 plays a greeting and provides brief instructions. The method then proceeds to decision block 96.

In block 96, system 10 determines, for example via appropriate use of text-to-speech unit 52 or prerecorded messages, and the physician's oral responses as analyzed by voice recognition unit 50, whether the physician's call is an enrollment call or a certification call. If it is an enrollment call, then the method branches to step 98, which activates an enrollment dialogue (described above in detail in connection with FIG. 7). However, if the call is a certification call, then the method braches to step 100.

In step 100, system 10 prompts the physician to provide identifying information so that it can check its database 46, which contains a listing of registered users. There are two embodiments for inputting information, whereby the physician can provide this identifying information to system 10. In a first, preferred, embodiment, system 10 utilizes its voice recognition function (via voice recognition unit 50) to obtain the information via spoken replies of the physician, telephonically over the telephone network, responsive to the prompts of system 10. In a second embodiment, the physician utilizes a telephone keypad input in response to system prompts. The method then proceeds to decision block 102.

In step 102, upon completing entry of identifying information, the system 10 is configured to check its database of registered users to determine whether the caller is a registered user who has completed a valid enrollment. Three scenarios are contemplated: (1) the caller is both registered and enrolled; (2) the caller is registered but not enrolled; and (3) the caller is not registered. Each scenario will be taken up in turn.

If the caller is registered and has completed a valid enrollment, system 10 will then proceed to authenticate that the identity claimed by the caller is correct by utilizing the voice authentication unit 48 of system 10. In this regard, system 10 obtains, telephonically over the telephone network on which the call is made, an authentication voiceprint. System 10, in conjunction with voice authentication unit 48, is configured to compare the reference voiceprint with authentication voiceprint, and generate an output data set therefrom. The output data set may comprise comparison score, a scaled rating from 0-100, as known to those of ordinary skill in the art. If the reference and authentication voiceprints meet the established matching criteria, the physician's identity has been authenticated. The physician is prompted to proceed with the electronic signature of any pending certificate(s), as in step 106. Otherwise, if either identification or authentication fails, the method branches to step 104.

If the caller is registered but has not completed a valid enrollment, then system 10 will direct the caller to complete a valid enrollment before proceeding and offer to connect the caller to an enrollment session (via step 98, although the transfer is not specifically shown in FIG. 4). Upon completion of a valid enrollment, the caller may then return to the processing of FIG. 4, preferably while on the same call, to complete an electronic signature of one or more pending certificates.

Finally, if the caller is not registered, then system 10 will inform the caller that registration and enrollment are required prior to use of system 10 and will provide directions on how to obtain registration information.

In step 104, the system allows the physician to either retry or to hang-up (terminate) the ongoing certification call. If the physician chooses “RETRY” then the method branches back to step 100. Otherwise, system 10 terminates the call.

In step 106, system 10 accesses database 46 to retrieve information regarding pending death certificates for the now authenticated physician. The method then proceeds to decision block 108.

In step 108, system 10 determines whether there are any pending death certificates for the authenticated physician to electronically sign. If the answer is “NO,” then system 10, through text-to-speech unit 52 or prerecorded audio messages, plays a message stating that no certificates are now pending, and then terminates the call. Otherwise, the method proceeds to step 112, wherein system 10 begins certificate processing.

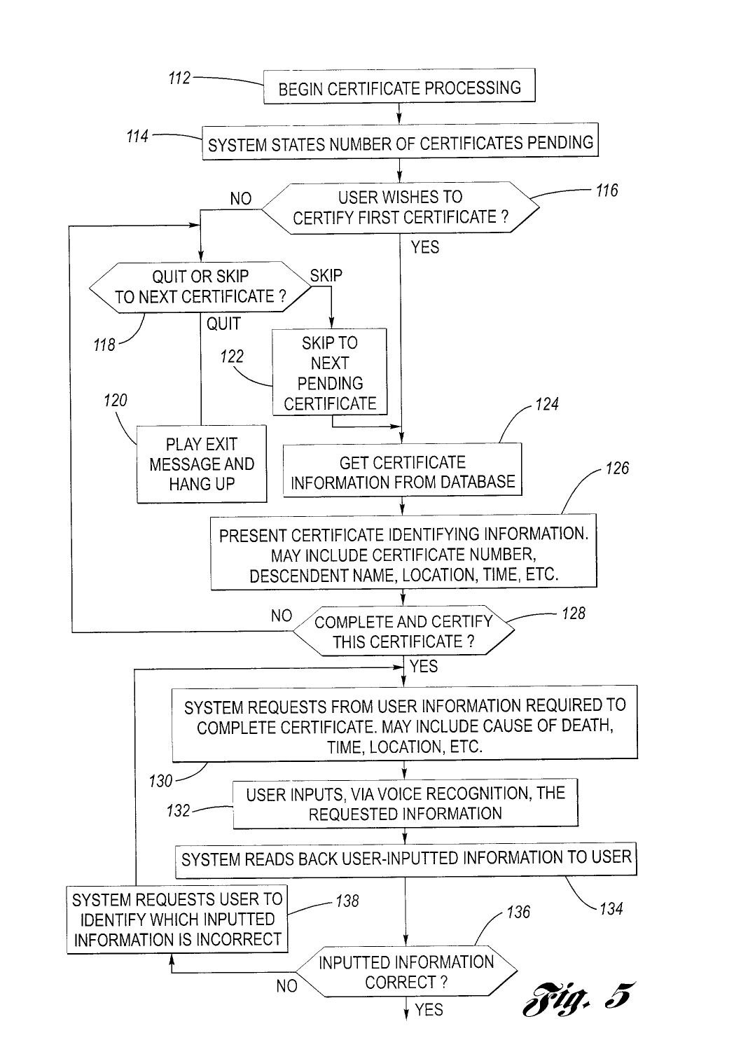

FIG. 5 shows, in greater detail, the certificate processing of system 10. The methodology starts in step 112, and then proceeds to step 114.

In step 114, system 10, via text-to-speech unit 52, states the number of certificates waiting to be signed by the now authenticated physician.

In decision block 116, system 10 asks the physician whether he/she wishes to certify the first death certificate. If physician's response (as recognized by voice recognition unit 50) is “YES” then the method branches to step 124, otherwise, if the answer is “NO,” then the method branches to decision block 118.

In decision block 118, system 10 asks the physician whether to he/she desires to “QUIT” or “SKIP” to the next pending certificate. If the answer is “QUIT,” then the method branches to step 120, wherein system 10 plays an exit message and terminates the call. Otherwise, if the answer is “SKIP,” then the method branches to step 122, wherein system 10 indexes to the next one of the pending certificates to be signed. Of course, if there is only one certificate to be signed, system 10 is configured not to provide the physician with the option to “SKIP” (there being no additional unsigned certificates to “skip” to). The method then proceeds step 124.

In step 124, system 10 retrieves information regarding the certificate to be signed from database 46, particularly portion 64 containing document information.

In step 126, system 10 presents to the physician information sufficient to allow the physician to definitely identify the death certificate. Such information may include, but is not limited to, a certificate number, a decedent name, a location or a time of death, or the like. This information is preferably communicated to the physician electronically during the voice call, using text-to-speech unit 52. This eliminates the shortcomings of conventional systems, which faxed or mailed draft death certificates to the physician, who would then have to keep track of the paper, and, in one conventional arrangement, have to “key in” data off the draft death certificate in order to identify it. The method then proceeds to decision block 128.

In block 128, system 10 asks the physician whether the information is complete, and whether the physician wishes to certify this pending certificate. If the answer is “NO” (do not certify), then the method branches to step 118 (“QUIT” or “SKIP”). Otherwise, if the answer is “YES” (certify), then the method may optionally perform steps 130, 132, 134, 136 and 138 to enter additional information into the death certificate.

Entering additional information is a feature of the method that warrants special consideration and discussion. As Background, laws and regulations regarding the entry of data into a death certificate vary widely. In some jurisdictions, a funeral director or other authorized party may enter virtually all of the information on a death certificate except the attending physician's signature. In other jurisdictions, only the attending physician is permitted to enter much of the information required on a death certificate. There are two embodiments according to the invention for gathering and entering the additional data required to complete an electronic death certificate.

In a first embodiment, in jurisdictions where permitted, the funeral director will have negotiated the cause of death and other medical and non-medical data for the certificate with the physician. This process may have occurred via telephone and/or fax and may be generally outside the actual signature ceremony. Once both the physician and the funeral director are satisfied with the accuracy and validity of the information to be entered, the funeral director enters the medical information on the issuing agency's death certificate registration system.

In a second embodiment, utilized in jurisdictions where only the attending physician may enter specific information such as cause of death, system 10 employs its voice recognition unit 50.

In step 130, the system 10 uses a series of recorded-voice or text-to-speech generated phrases to request information from the physician required to complete the death certificate. For example, such information may include the cause of death, the time of death, the location, and the like.

In step 132, the voice recognition unit 50 captures the physician's spoken replies made telephonically over the telephone network.

In step 134, preferably, the system 10 reads back to the physician what it thinks it heard, and then prompts the physician to affirm that the information entered is correct.

In decision block 136, asks the physician whether the inputted information is correct. If the physician's reply is “NO” (incorrect), then the method branches to step 138, wherein the system 10 asks the physician to identify which inputted information is incorrect, and the method loops back to step 130 (System Prompts for information). Otherwise, if the physician's answer is “YES” (information correct), then the system 10 converts the spoken entries into textual information that is inserted into a data record that will be sent back to the issuing agency's death certificate registration system. The method then proceed to the final “certification” or electronic signing of the certificate.

This voice recognition functionality described in connection with steps 130-138 improves on the conventional art, which contemplated that the user would enter information through a difficult sequence of key-presses or the like on the phone.

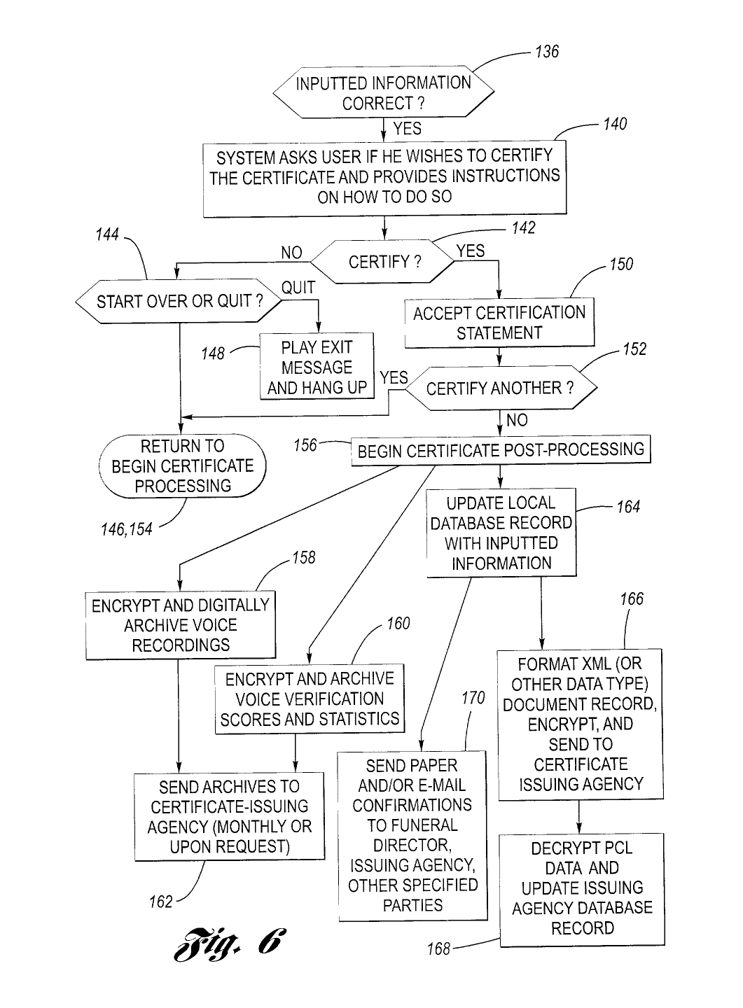

FIG. 6 shows, in greater detail, the processing involved in system 10 in certifying a document, and post-processing. The method begins with the “YES” answer by the physician (that the entered information is correct).

In step 140, when all of the information required to complete the electronic death certificate has been acquired, the physician then proceeds to the certification portion of the call. The system 10 reads required identifying information from the pending certificate and asks the physician to affirm that the presented pending certificate is the one which is to be certified. If the physician affirms that the information is correct, the PCL system 10 asks that the physician speak a specific certification word or phrase, typically the word “certify”. The physician's reply is captured, and the method proceeds to decision block 142.

In block 142, system 10, through it voice recognition unit 50, determines whether the spoken reply matches the predetermined certification phrase. If the physician's reply is insufficient to certify or sign the certificate (“NO”), then the method branches to decision block 144, otherwise, if the physician's reply is “YES,” then the method branches to step 150.

In block 144, system 10 asks the physician if he/she wishes to “START OVER” or “QUIT”. If the answer is “QUIT,” then the method branches to step 148, wherein system 10 plays an exit message and the call is terminated. Otherwise, if the answer is “START OVER,” then the method branches to step 146, which is a transfer point which takes the physician back to the beginning of certificate processing (e.g., step 112 in FIG. 5).

In step 150, upon recognition of the word “certify” (or other certification phrase), system 10 will then create certification data with the current date and time as well as the digital audio recording of the physician saying his/her name, and saying “certify”. This certification data will then be added to the complete data record for the electronic death certificate. The PCL system 10 then tells the physician that certification was successful and that the information will be sent to the certificate issuing agency. Upon completion of the certification portion of the call, the data record is locked from any further changes.

It bears emphasizing that what has occurred constitutes an electronic signature. According to the invention, a unique numeric or alpha-numeric code is generated system 10 based on data extracted from various reference values gathered during the physician's interaction with system 10. These values may include the mathematical representation of the physician's voiceprint, dates, times, names, locations or other information. Alternatively, a randomly-generated unique numeric or alpha-numeric code may be used.

The generated, unique code, which can only be created upon completion of a successful voiceprint biometric user authentication, is then included in the data record associated with each electronic death certificate.

This unique code meets the specific legal criteria set forth for electronic signatures as set forth in the Electronic Signature in Global and National Commerce Act, or “E-SIGN” bill of Oct. 1, 2000, which describes an electronic signature as “an electronic sound, symbol, or process, attached to or logically associated with a contract or other records and executed or adopted by a person with the intent to sign the record.” In addition, this code meets the other legal and industry standard criteria for electronic signatures which include:

(1) sender authentication (verification of the sender)

(2) message integrity (confirmation that message was not tampered with in transit)

(3) non-repudiation (confirmation that the sender cannot deny the message or signature was sent)

The format of the physical representation of this electronic signature on printed hardcopy documents is at the discretion of the certificate issuing agency, but will typically be a numeric code with a difficult-to-reproduce background seal or identifying mark. An optional method is for the certificate issuing agency to store an electronic copy of the physician's actual signature, gathered via scanned document or electronic signature pad, and to print a copy of the stored signature on the certificate.

With continued reference to FIG. 6, in decision block 152, system 10 asks the physician whether he/she desires to certify another pending certificate (if there are any). If the answer is “YES,” then the method branches to step 154, which is a transfer point which takes the physician back to the beginning of certificate processing (e.g., step 112 in FIG. 5). Otherwise, if the answer is “NO,” then the method proceeds to step 156, the beginning of certificate post-processing.

Upon successful completion of the data acquisition, certification, and generation of an electronic signature, a number of processes are initiated to complete the transaction and are described below.

In steps 158 and 160, system 10 encrypts and digitally archives the voice recordings, voice verification scores, and other statistics related to the certificate signing transaction. In one embodiment, these archives will be held by system 10 in database 46 (or other data archival mechanisms) for a period of time, for example, as may be specified by the certificate issuing agency. In step 162, such archives may be subsequently sent to the certificate issuing agency for storage. If step 162 is performed in any particular embodiment, the transmission of these archives to the agency (or its designated entity) will generally occur at times specified by the certificate issuing agency.

In step 164, system 10 performs the step of updating database 46 with information related to the certificate that has been processed. All new data acquired, the certification status, and the signature code are added to the data record that was initially acquired from the certificate issuing agency's EDR system 12.In step 166, system 10 performs the step of formatting a data-exchange record, which may have a format complying with XML, but may be another data type depending on the certificate issuing agency's requirements. This data-exchange record includes all of the information in the PCL system's local database record of the transaction as described above, as well as any additional information required by the certificate issuing agency to facilitate data exchange. In addition, system 10 is further configured to perform the step of encrypting the data-exchange record. The specific type of encryption will be determined by the certificate issuing agency in accordance with its capabilities and requirements, but a typical example would use industry-standard encryption methodologies, such as Public Key Infrastructure (PKI), Data Encryption Standard (DES) , or Kerberos. Moreover, system 10 is adapted to electronically transmit the encrypted data record to the certificate issuing agency (e.g., system 12), typically via an Internet connection, but may also include other methods of electronic data communication as specified by the certificate issuing agency.In step 168, the certificate issuing agency receives the encrypted package, then decrypts the same and updates its own database.

In step 170, system 10 performs the step of sending confirmations to all participants at specified time periods, typically monthly, but may be at any other periodic interval, or may be upon demand, or other criteria. The confirmation may comprise a respective report describing all certifications performed under that participant's authority. For example, (1) the physician may receive a report detailing his/her certifications for the month; (2) the funeral director may receive confirmations for all his/her accounts regardless of the physician; (3) the county will receive all certifications performed for that county; and (4) the certificate issuing agency (typically a state) may receive all certifications in its jurisdiction. This report, for example, may have a single line for each signature or certification detailing the name, number, signature code and when it was certified and by whom. This confirmation may be sent via e-mail, fax, private courier, U.S. mail or any other known means of delivery now known or hereafter developed, depending on the election of the participant.

Another feature of the present invention involves the capability to provide verification of the “signed” document to interested parties (best shown in FIG. 1 for public 38 and request for verification 40). An electronic signature that is printed on a death certificate may be verified upon request, for example made in writing or by way of e-mail to system 10 (or a designated entity) or the certificate issuing agency. Upon receipt of the request to verify a signature, system 10 will extract the signature code and look up the record in its database 46. If this process results in locating a record, system 10 will return to the requestor, for example via email or hardcopy, a message detailing the name of deceased, the date of death, the name of the certifier (e.g., the physician) and the date/time of the certification.

The system 10, in one embodiment, may return a failure message when the record does not exist. Such a failure message may provide the detail that provided signature code, namely, signature code XXXXXXXX-XXXX, could not be located. System 10, in such an embodiment, does not attempt to try again to locate the record, nor does provide any reasons in the message for the failure (i.e., not found, database could not be opened, etc).

Although the invention herein has been described with reference to particular embodiments, it is to be understood that the embodiments are merely illustrative of the principles and application of the present invention. It is therefore to be understood that various modifications may be made to the above mentioned embodiments and that other arrangements may be devised without departing from the spirit and scope of the present invention.

As further example, an electronic death registration method may comprise obtaining electronically via the Internet a physician's certification of a death certificate and verifying the physician's identity using biometric technologies, such as finger-scans or facial-scans, and transmitting that verification or the actual biometric electronically. The certified death certificate may be forwarded to a state health department electronically, and may be recorded and stored electronically so that the certificate and any information on the certificate may be retrieved at a later time.

Similar electronic registration methods and systems may be created for other documents, transactions or events in accordance with the principles of the present invention. Examples of such documents, transactions or events include birth registration, marriage or divorce registration, medical prescription, medical records, licensing, permit applications, and others. Additional methods of biometric security may also be used to verify that the certifier is actually the party they purport to be. Examples of such biometrics are Hand geometry scan, Retina-scan, Iris-scan, Signature-scan or others.

1. A method for facilitating an electronic signature of a document comprising the steps of:
(A) telephonically authenticating a signer using biometrics;
(B) telephonically performing, using voice recognition, at least one of the group comprising (i) identifying the document; (ii) entering data into the document; (iii) affirming data in the document; and
(C) telephonically receiving the signature.

2. The method of claim 1 further including the step of:
obtaining a reference voiceprint of the signer; and,
storing the reference voiceprint for subsequent comparison.

3. The method of claim 2 wherein said step of biometrically authenticating the signer includes the substeps of:
obtaining an authentication voiceprint from the signer using over a telephone system;
comparing the authentication voiceprint with the reference voiceprint and generating an output data set therefrom;
authenticating the signer when the output data set meets predetermined criteria.

4. The method of claim 2 further comprising repeating said steps of identifying the document using voice recognition and signing the document for a plurality of documents during a single telephone call.

5. The method of claim 4 wherein said repeating step includes the substeps of:
after said step of signing the document, generating a first message for the signer indicative of a number of remaining documents to be signed;
producing a second message for the signer asking whether the signer desires to sign a further one of the plurality of documents;
receiving a further signature for the further document using the telephone system.

6. The method of claim 2 further including the steps of:
authenticating the signer using an identifier to authenticate the identity of the signer;
associating the reference voiceprint with the authenticated signer to complete an enrollment; and
performing said step of telephonically authenticating the signer using biometrics a plurality of times.

7. The method of claim 6 further including the step of:
selecting the identifier from the group comprising a password, a personal identification number (PIN) and a mechanism that uniquely identifies the signer.

8. The method of claim 3 further comprising the step of:
generating an audit record that includes the output data set from said telephonically authenticating step using biometrics.

9. The method of claim 1 wherein the document is one selected from the group comprising a death certificate, a birth certificate, a marriage certificate, a divorce certificate, a vital statistic document, a medical record, and a medical drug prescription.

10. A method for facilitating an electronic signature of a document comprising the steps of:
(A) receiving an identifier from a signer over a telephone system;
(B) confirming the identity of the signer when the identifier corresponds to a predetermined reference identifier;
(C) obtaining a reference voiceprint from the signer over the telephone system using a first device to thereby enroll the signer;
(D) obtaining an authentication voiceprint from the signer over the telephone system to authenticate the signer;
(E) identifying the document using voice recognition; and
(F) receiving the signature using the telephone system.

11. The method of claim 10 wherein steps (A), (B) and (C) are performed during a first call over the telephone system and steps (D), (E) and (F) are performed during a second call over the telephone system.

12. The method of claim 10 further including the step of:
comparing the authentication voiceprint with the reference voiceprint and generating an output data set therefrom;
authenticating the signer when the output data set meets predetermined criteria.

13. The method of claim 12 further comprising repeating said steps of identifying the document using voice recognition and signing the document using the telephone system for a plurality of documents during a single telephone call.

14. The method of claim 12 further including the step of:
selecting the identifier from the group comprising a password, a personal identification number (PIN) and a mechanism that uniquely identifies the signer.

15. The method of claim 12 further comprising the step of:
generating an audit record that includes the output data set from the authenticating step.

16. The method of claim 10 further comprising the step of:
obtaining a plurality of reference voiceprints over the telephone system using a corresponding plurality of devices.

17. A system for facilitating an electronic signature comprising:
means for authenticating a signer based on an authentication voiceprint received from said signer over a telephone network;
means for identifying a document to be signed based on a first speech sequence received from said authenticated signer over the telephone network, said identifying means comprising a voice recognition device; and
means for receiving a second speech sequence corresponding to said signature from said authenticated signer over said telephone network.

18. The system of claim 17 further comprising:
means for obtaining a reference voiceprint of said signer;
means for receiving at least a portion of said document from a registration system; and
a database for storing said reference voiceprint for subsequent comparison to said authentication voiceprint.

19. The method of claim 18 wherein said authenticating means includes:
means for comparing said authentication voiceprint with said reference voiceprint and generating an output data set therefrom, and wherein said database includes said output data set.
